(19) United States
(12) Patent Application Publication
(10) Pub. No.: US 2026/0356348 A1
(43) Pub. Date: Nov. 12, 2026

(54) CONTROL METHOD FOR HYBRID VEHICLE AND CONTROL DEVICE FOR HYBRID VEHICLE

(71) Applicant: NISSAN MOTOR CO., LTD., Yokohama-shi (JP)

(72) Inventors: Taichi ANDOU, Kanagawa (JP); Yusuke FUJITA, Kanagawa (JP)

(73) Assignee: NISSAN MOTOR CO., LTD., Yokohama-shi (JP)

(21) Appl. No.: 19/672,428

(22) Filed: May 8, 2026

(30) Foreign Application Priority Data
May 9, 2025 (JP) 2025-078454

(51) Int. Cl. B60W 20/13; B60W 10/06; B60W 10/08

(52) U.S. Cl. CPC B60W 20/13; B60W 10/06; B60W 10/08; B60W 2510/0652; B60W 2510/0657; B60W 2510/083; B60W 2510/244; B60W 2710/0666; B60W 2710/086; B60W 2710/244

(57) ABSTRACT

A hybrid vehicle 1 includes an internal combustion engine 9 for electric power generation which is mounted on the hybrid vehicle 1 and a generator 8 connected to drive synchronously with the internal combustion engine. In the hybrid vehicle 1, the difference between the command torque for the internal combustion engine 9 and the power generation torque of the generator 8 is continuously calculated, and the internal combustion engine 9 is controlled such that the power generation torque approaches the command torque by using the difference as an error amount of the torque generated in the internal combustion engine 9, which is applied as a correction amount to the intake air amount of the internal combustion engine 9.

### BACKGROUND

The present invention relates to a control method for a hybrid vehicle and a control device for a hybrid vehicle.

For example, a Japanese Patent Application Publication No. 2017-013583 (hereinafter is simply referred to as a “patent document 1”) discloses a technique for a hybrid vehicle in which an internal combustion engine and a motor generator are connected via a clutch as power sources, for estimating variations in torque and friction of the internal combustion engine while the internal combustion engine and the motor generator are connected by the clutch, and for learning and correcting the torque of the internal combustion engine based on the estimated variations.

In the patent document 1, an engine operating point requiring learning is defined using an engine torque command value and a motor generator rotational speed command value (engine speed command value), and the learning correction is performed during operation at this point.

However, the learning correction in the patent document 1 is performed under the premise that the engine speed of the internal combustion engine is maintained constant and cannot be performed when the torque generated by the internal combustion engine and the power generation torque of the motor generator are not balanced.

In other words, when learning for the engine operating point requiring learning has not been performed, there is a risk that the torque of the internal combustion engine cannot be controlled accurately. That is, in a hybrid vehicle having a motor generator coupled to drive synchronously with the internal combustion engine, there is room for further improvement to enhance the accuracy of the power generation torque of the motor generator with respect to the command torque of the internal combustion engine.

### SUMMARY

A control method for a hybrid vehicle including an internal combustion engine for electric power generation which is mounted on the hybrid vehicle and a motor generator connected to drive synchronously with the internal combustion engine, the method comprising: calculating a difference between a command torque for the internal combustion engine and a power generation torque of the motor generator; and controlling the internal combustion engine such that the power generation torque approaches the command torque for the internal combustion engine by using the difference as a correction amount to an intake air amount of the internal combustion engine.

According to the hybrid vehicle of the present invention, it is possible to improve to enhance the accuracy of the power generation torque of the motor generator with respect to the command torque of the internal combustion engine.

### BRIEF DESCRIPTION OF THE DRAWINGS

FIG. 1 is a schematic diagram showing the system configuration of a hybrid vehicle to which the present invention is applied.

FIG. 2 is a timing chart showing an example of changes in various parameters when charging of a battery is limited during the operation of the internal combustion engine.

FIG. 3 is a block diagram showing an example of the control flow for the internal combustion engine in the hybrid vehicle.

FIG. 4 is a block diagram showing an example of a calculation procedure for a target total compensated indicated torque.

FIG. 5 is a block diagram showing an example of a calculation procedure for a torque difference based on FB amount (hereinafter referred to as a “FB-amount-based torque difference”).

FIG. 6 is a block diagram showing an example of a calculation procedure for a torque difference based on GEN torque (hereinafter referred to as a “GEN-torque-based torque difference”).

FIG. 7 is a block diagram showing an example of a calculation procedure for a torque difference based on engine speed (hereinafter referred to as “engine-speed-based torque difference”).

FIG. 8 is a block diagram showing an example of a calculation procedure for a torque difference before limitation.

### DETAILED DESCRIPTION

In the following, an embodiment of the present invention will be described in detail based on the drawings.

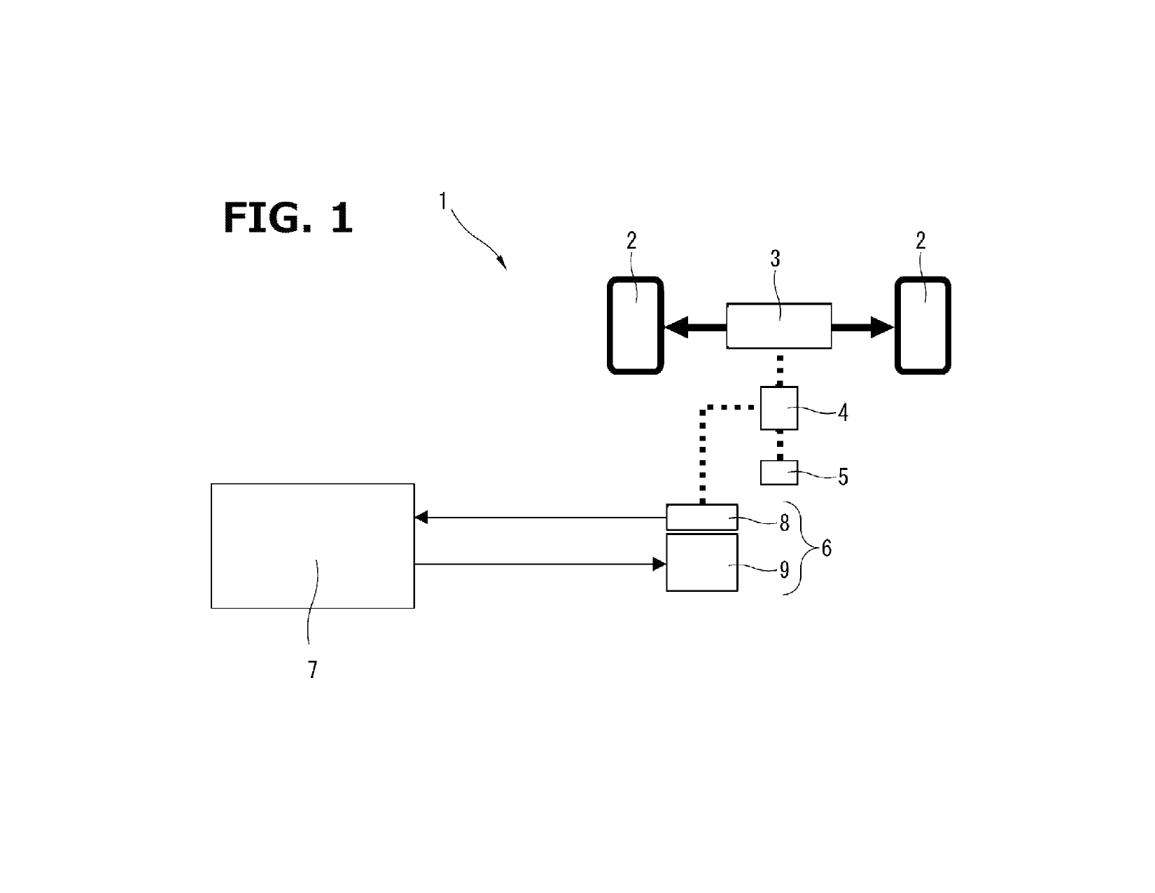

FIG. 1 is an explanatory diagram schematically showing the system configuration of a hybrid vehicle 1 to which the present invention is applied.

The hybrid vehicle 1 includes a drive wheel 2 of the hybrid vehicle 1, a drive motor 3 for rotating and driving the drive wheel 2, an inverter 4 for supplying electric power to the drive motor 3, a battery 5 and a power generation unit 6 capable of supplying electric power to the inverter 4, and a control unit 7 for controlling the power generation unit 6.

The hybrid vehicle 1 is a series hybrid vehicle in which the rotation of the crankshaft of an internal combustion engine (engine) 9, described later, is not transmitted to the drive wheel 2. For example, when the state of charge of the battery 5 becomes low, electric power is generated by the power generation unit 6 to charge the battery 5.

The drive wheel 2 is rotated and driven by the drive motor 3 as a drive source.

The drive motor 3 is a drive source of the hybrid vehicle 1 and is driven by AC power from the inverter 4. Furthermore, the drive motor 3 can charge the battery 5 with regenerative energy generated during vehicle deceleration as electric power via the inverter 4.

The inverter 4 is a power conversion circuit that converts electric power generated by the power generation unit 6 or the drive motor 3 into DC power and supplies it to the battery 5. The inverter 4 is also a power conversion circuit that converts DC power output from the battery 5 into AC power and supplies it to the drive motor 3.

The battery 5 is a secondary battery capable of charging the electric power generated by the power generation unit 6 or the drive motor 3 as DC power, and supplies the charged electric power to the drive motor 3 via the inverter 4.

The power generation unit 6 is mainly composed of a generator 8 functioning as a motor generator and an internal combustion engine 9 for electric power generation that drives the generator 8. The power generation unit 6 is configured such that the rotation of the crankshaft of the internal combustion engine 9 is transmitted to the rotor of the generator 8 via a speed reduction mechanism (not shown). The power generation unit 6 is configured to operate (start and stop) independently of the drive motor 3.

The generator 8 is, for example, a synchronous motor using a permanent magnet in its rotor (not shown), and generates electric power supplied to drive motor 3. The generator 8 is connected to drive synchronously with the rotation of the internal combustion engine 9. That is, the generator 8 is directly connected to the internal combustion engine 9. In other words, the generator 8 is connected to the internal combustion engine 9 without a clutch. Furthermore, the generator 8 may be used as a starter motor at the time of the starting of the internal combustion engine 9.

The internal combustion engine 9 is, for example, a spark-ignition-type internal combustion engine and is mounted on the hybrid vehicle 1. The internal combustion engine 9 is mounted for electric power generation purposes.

The control unit 7 is a well-known digital computer equipped with a CPU, ROM, RAM, and input/output interface. The control unit 7 is configured to control the operation of the internal combustion engine 9. Specifically, the control unit 7 controls the operation of the internal combustion engine 9 such that the engine speed and torque of the internal combustion engine 9 reach desired values. Furthermore, the control unit 7 is capable of detecting the power generation torque of the generator 8.

Here, the rotational speed in the power generation unit 6 (power generation system) is controlled by the servo function of the generator 8. That is, the control unit 7 controls the rotational speed in the power generation unit 6 (power generation system) using the servo function of the generator 8. The servo function of the generator 8, for example, increases or decreases the rotational resistance of the generator 8 to match the rotational speed of the generator 8 with a target rotational speed of the generator 8. By matching the rotational speed of the generator 8 with the target rotational speed of the generator 8 via the servo function of the generator 8, the engine speed of the internal combustion engine 9 which is directly connected to the generator 8 also matches the target engine speed. That is, the engine speed of the internal combustion engine 9 is controlled by the servo function of the generator 8 so as to match the target engine speed of the internal combustion engine 9.

Furthermore, the control unit 7, serving as a control section, continuously calculates the difference between the command torque for the internal combustion engine 9 and the power generation torque of the generator 8, and this difference is used as an error amount of the torque generated in the internal combustion engine 9, which is applied as a correction amount to the intake air amount of the internal combustion engine 9. That is, the control unit 7 uses the above difference as a correction amount to the intake air amount and performs feedback control of the internal combustion engine 9 such that the power generation torque approaches the command torque for the internal combustion engine 9.

With this, in the hybrid vehicle 1, it is possible to improve the accuracy of the power generation torque with respect to the command torque for the internal combustion engine 9.

Furthermore, in the hybrid vehicle 1, when a limitation on the charging of the battery 5 occurs and the electric power generated by the generator 8 is limited, the difference between the command torque for the internal combustion engine 9 and the power generation torque of the generator 8 which is the error amount of the torque generated in the internal combustion engine 9 is detected, and then the intake air amount is controlled using this difference as a correction amount such that the power generation torque approaches the command torque.

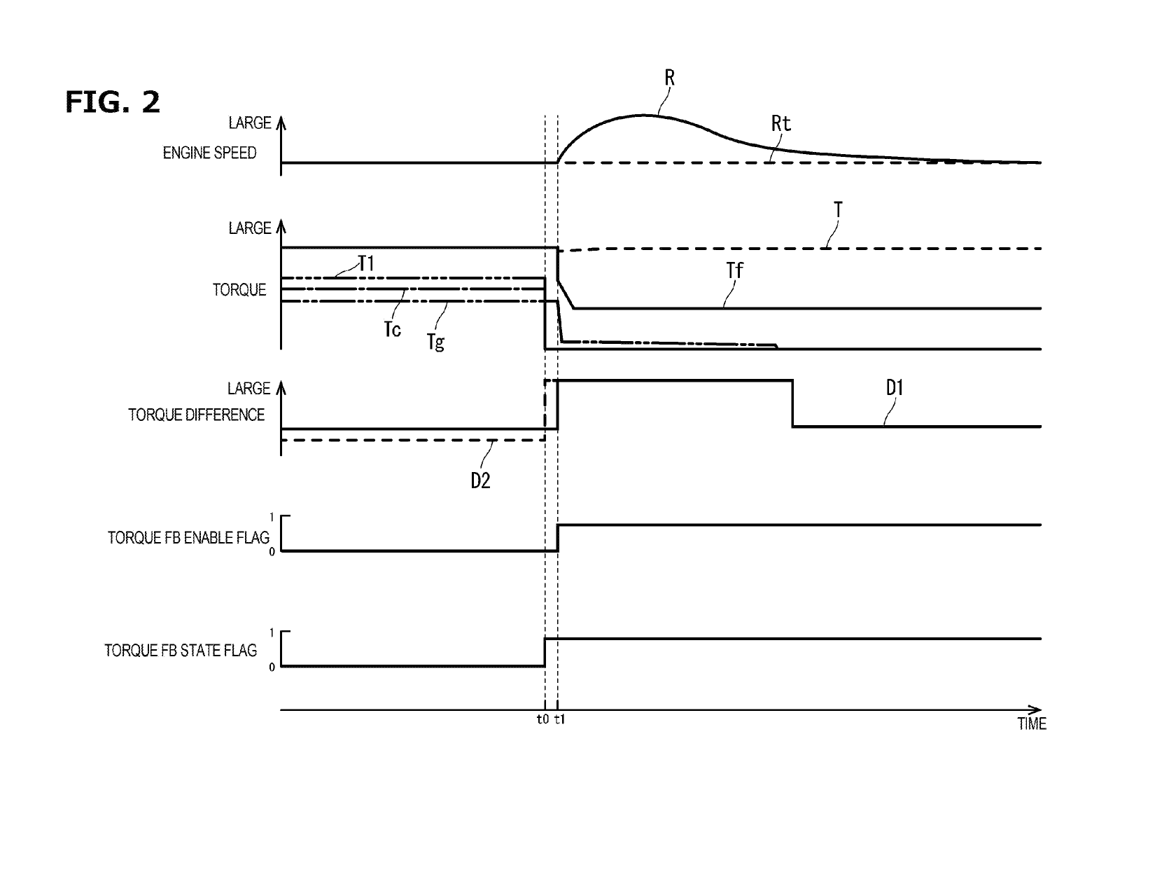

Therefore, in the hybrid vehicle 1, even when the charging of the battery 5 is limited, it is possible to improve the accuracy of the power generation torque of the generator 8 with respect to the command torque for the internal combustion engine 9. Furthermore, in the hybrid vehicle 1, as shown in FIG. 2, when the charging of the battery 5 is limited, it is possible to suppress an increase in engine speed of the internal combustion engine 9 by limiting the electric power generated by generator 8.

FIG. 2 is a timing chart showing an example of changes in various parameters when the charging of the battery 5 is limited during the operation of the internal combustion engine 9 in the hybrid vehicle 1 of the above-described embodiment. A time t0 in FIG. 2 is a timing at which a condition for limiting charging of the battery 5 is satisfied. Furthermore, a time t1 in FIG. 2 is a timing at which feedback control of the internal combustion engine 9 starts based on the torque difference, such that the power generation torque approaches the command torque for the internal combustion engine 9.

A characteristic line R shown by a solid line in FIG. 2 represents the engine speed of the internal combustion engine 9. A characteristic line Rt shown by a dashed line in FIG. 2 represents a target engine speed of the internal combustion engine 9.

A characteristic line T shown in a dashed line in FIG. 2 represents an indicated torque after compensation that does not include an FB correction amount (torque difference FB amount). In addition, the compensated indicated torque may be calculated such that the torque reduction amount according to the amount of retard is compensated, when the ignition timing of the internal combustion engine 9 is retarded from the MBT point. A characteristic line Tf shown by a solid line in FIG. 2 represents a compensated indicated torque including the FB correction amount (torque differential FB amount). A characteristic line Tc shown by a single-dot-dash line in FIG. 2 represents the command torque for the internal combustion engine 9. A characteristic line Tg shown by a double-dot-dash line in FIG. 2 represents the power generation torque of the generator 8. A characteristic line T1 shown by a triple-dot-dash line in FIG. 2 represents a power generation limiting torque (GEN power generation limiting torque) of the internal combustion engine 9.

A characteristic line D1 shown by a solid line in FIG. 2 represents the torque difference between the command torque for the internal combustion engine 9 and the power generation torque of the generator 8. A characteristic line D2 shown by a dashed line in FIG. 2 represents the torque difference based on a torque difference based on GEN torque (hereinafter referred to as a “GEN-torque-based torque difference”).

A torque FB state flag is switched to “1” at a time t0. The torque FB state flag is set to “1” when, for example, the operating state of the internal combustion engine 9 is in a predetermined high-torque operating state, predetermined low-torque operating state, or MBT operation where torque is maximized under the same states.

A torque FB operation enable flag is switched to “1” at the time t1. The torque FB enable flag becomes “1” when, for example, the torque FB state flag is “1” and the internal combustion engine 9 is in a steady state. Here, the steady state of the internal combustion engine 9 refers, for example, to a state in which the torque difference in the GEN-torque-based torque difference is stable.

Furthermore, the control unit 7 is capable of detecting an SOC (State Of Charge) which is the ratio of the remaining charge amount relative to a battery capacity of the battery 5. For example, when the battery SOC of the battery 5 is high and a limitation on charging of the battery 5 occurs, the control unit 7 applies a limit to the electric power generated by the generator 8. In other words, the control unit 7 applies a limit to the electric power generated by the generator 8 when a limitation on charging of the battery 5 occurs due to a state of the battery 5.

In case where there is a combustion continuation request of the internal combustion engine 9 when a limitation on charging of the battery 5 occurs, control unit 7 limits the electric power generated by the generator 8 and calculates the command torque for the internal combustion engine 9 according to this electric power limitation. Here, the combustion continuation request of the internal combustion engine 9 occurs, for example, when there is a request for heating the cabin of the hybrid vehicle 1.

In case where the torque generated by the internal combustion engine 9 increases and the engine speed increases when a limitation on charging of the battery 5 occurs, the control unit 7 calculates the difference between the command torque for the internal combustion engine 9 and the power generation torque of the generator 8 using the rate of increase in the engine speed of the internal combustion engine 9. Furthermore, in case where the torque generated by the internal combustion engine 9 increases and the engine speed increases when a limitation on charging of the battery 5 occurs, the control unit 7 stops the servo function of the generator 8 to protect it.

In the hybrid vehicle 1, when the torque generated by the internal combustion engine 9 exceeds the GEN power generation limiting torque which is a predetermined allowable limit torque determined by the specifications of the generator 8, the engine speed of the internal combustion engine 9 is increased using the excess torque generated by the internal combustion engine 9 to protect the generator 8. Therefore, when the torque generated by the internal combustion engine 9 exceeds the allowable limit torque of the generator 8, the control unit 7 calculates the difference between the command torque for the internal combustion engine 9 and the power generation torque of the generator 8 using the rate of increase in engine speed of the internal combustion engine 9. The allowable limit torque corresponds to the GEN power generation limiting torque.

With this, in the hybrid vehicle 1, it is possible to improve control of the torque generated by the internal combustion engine 9 relative to the allowable limit torque of the generator 8.

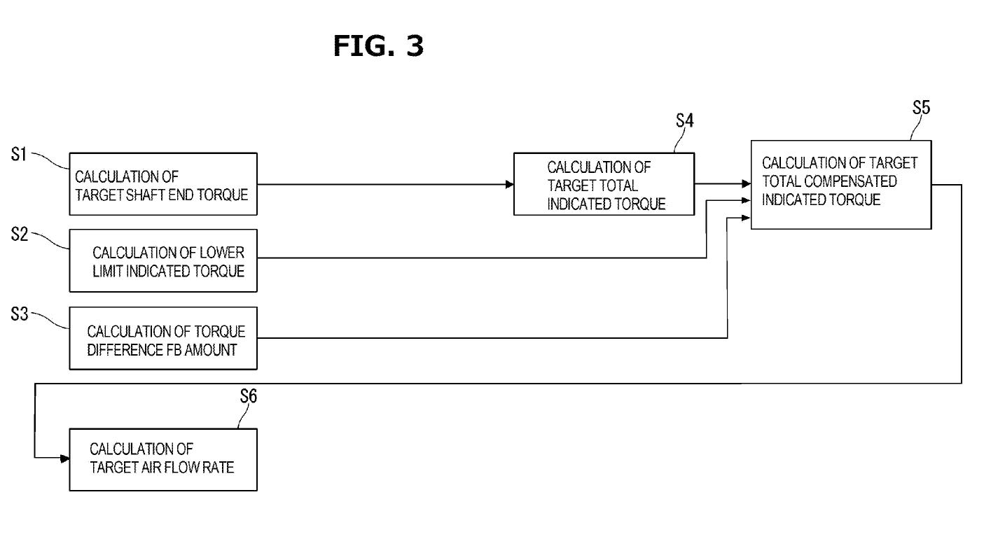

FIG. 3 is a block diagram showing an example of the control flow for the internal combustion engine 9 in the hybrid vehicle 1 of the above-described embodiment.

In a step S1, a target shaft end torque which is a target torque to be output at an end of the crankshaft of the internal combustion engine 9 is calculated.

In a step S2, a predetermined lower limit indicated torque determined according to the specifications of the internal combustion engine 9 is calculated (read).

In a step S3, a torque difference FB amount is calculated.

In a step S4, a target total indicated torque is calculated. In addition, the target total indicated torque is calculated taking into account friction and pump loss of the internal combustion engine 9.

In a step S5, a target total compensated indicated torque is calculated. The target total compensated indicated torque may be calculated such that a decrease amount of the torque corresponding to the retard is compensated when the ignition timing of the internal combustion engine 9 is retarded from the MBT point.

In a step S6, a target air flow rate (target air amount) is calculated using the target total compensated indicated torque calculated in the step S5. The target air flow rate is an intake air amount of the internal combustion engine 9 which is corrected according to the difference between the command torque for the internal combustion engine 9 and the power generation torque of the generator 8. The control unit 7 controls the internal combustion engine 9 using the intake air amount calculated in the step S6.

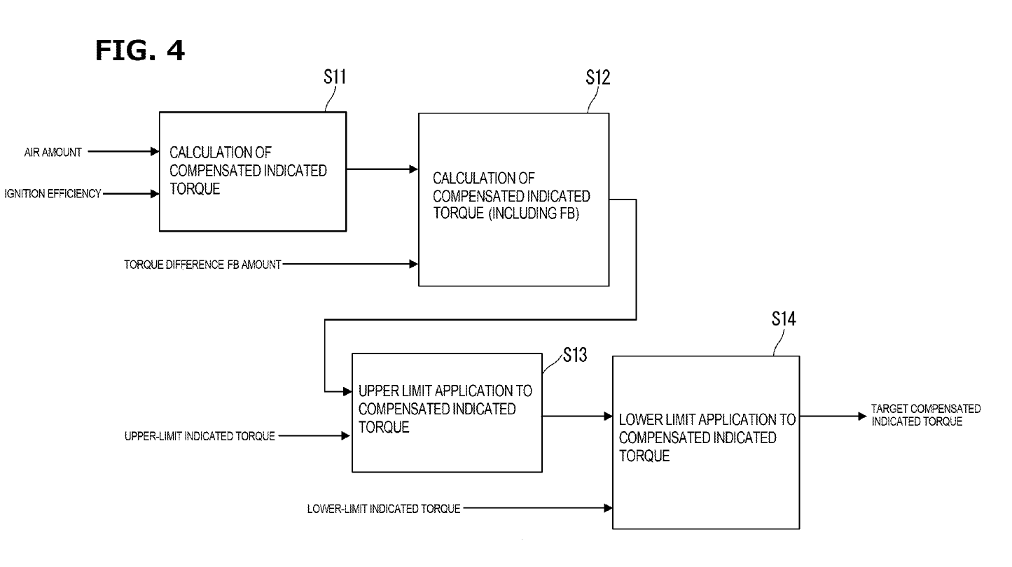

FIG. 4 is a block diagram showing an example of the calculation procedure for the target total compensated indicated torque calculated in the step S5 of FIG. 3.

In a step S11, a compensated indicated torque is calculated using the air amount (intake air amount) and the ignition efficiency of the internal combustion engine 9. The compensated indicated torque is obtained, for example, by dividing the indicated torque calculated using the air amount by the ignition efficiency. In addition, the compensated indicated torque may be calculated such that a decrease amount of torque corresponding to the retard is compensated when the ignition timing of the internal combustion engine 9 is retarded from the MBT point.

In a step S12, a compensated indicated torque (including FB) is calculated using the torque difference FB amount and the compensated indicated torque calculated in the step S11. The compensated indicated torque is obtained, for example, by adding the torque difference FB amount to the compensated indicated torque calculated in the step S11.

In a step S13, an upper limit is applied to the compensated indicated torque using the compensated indicated torque (including FB) and an upper-limit indicated torque. The upper-limit indicated torque is, for example, a predetermined set value. In the step S13, the values of the compensated indicated torque (including FB) and the upper-limit indicated torque are compared, and a smaller value (select-low) is set as a compensated indicated torque to which the upper limit has been applied.

In a step S14, a lower limit is applied to the compensated indicated torque using the upper-limit-applied compensated indicated torque and the lower-limit indicated torque. In the step S14, the values of the upper-limit-applied compensated indicated torque and the lower-limit indicated torque are compared, and a larger value (select-high) is set as a compensated indicated torque to which the lower limit has been applied. The lower-limit-applied compensated indicated torque calculated in the step S14 is a compensated indicated torque to which the upper limit has been applied and which is calculated taking into account the torque difference FB amount, and is a compensated indicated torque corresponding to the target compensated indicated torque calculated in the step S5 of FIG. 3 described above.

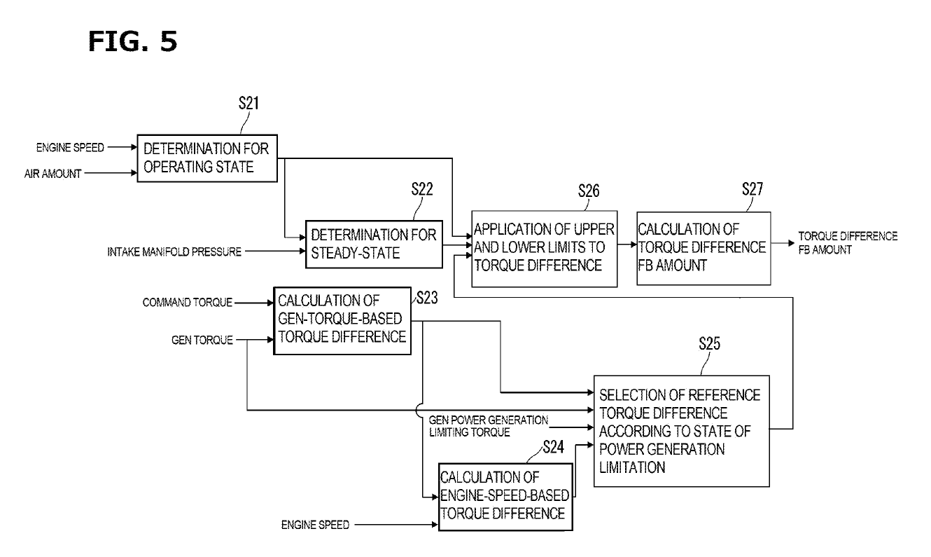

FIG. 5 is a block diagram showing an example of the calculation procedure for the torque difference FB amount calculated in the step S3 of FIG. 3.

In a step S21, the operating state is determined using the engine speed and air amount (intake air amount) of the internal combustion engine 9. When the internal combustion engine 9 is in a predetermined high-torque operation, predetermined low-torque operation, or MBT operation where torque is maximized under the same states, the torque FB state representing the operating state is determined to be “1”. When the internal combustion engine 9 is not in the predetermined high-torque operation, predetermined low-torque operation, or MBT operation, the torque FB state is determined to be “0”.

In a step S22, a steady-state determination of the internal combustion engine 9 is performed, and the state of a torque FB operation flag is determined. In the step S22, for example, it is determined whether the internal combustion engine 9 is in a steady state, based on a change in an intake manifold pressure (intake pressure within the intake manifold) of the internal combustion engine 9. In the step S22, when the internal combustion engine 9 is in a steady state and the torque FB state is “1”, the torque FB operation flag is set to “1”. In the step S22, when the internal combustion engine 9 is in a transient state or the torque FB state is ‘0’, the torque FB operation flag is set to “0”.

In a step S23, a torque difference based on GEN torque (hereinafter referred to as a “GEN-torque-based torque difference”) that is a torque difference between the command torque of the internal combustion engine 9 and the power generation torque (GEN torque) of the generator 8 is calculated using the command torque and the power generation torque (GEN torque).

In a step S24, the torque difference based on engine speed (hereinafter referred to as an “engine-speed-based torque difference”) that is a torque difference based on the rate of increase in engine speed of the internal combustion engine 9 is calculated using the engine speed of the internal combustion engine 9 and the GEN-torque-based torque difference.

In a step S25, a torque difference before limitation that is a reference torque difference corresponding to the power generation limited state is calculated using the power generation torque, the GEN-torque-based torque difference, the engine-speed-based torque difference, and a predetermined GEN power generation limiting torque.

The GEN power generation limiting torque is a predetermined value set for protecting the battery 5 or the generator 8 and is a value which varies depending on the situation. That is, the GEN power generation limiting torque has different values in a case of the protection of the battery 5 and in a case of the protection of the generator 8. The GEN power generation limiting torque is set based on whether the situation requires protecting the battery 5 or the generator 8.

In a step S26, a torque difference to which upper and lower limits have been applied is calculated using the torque FB state, the torque FB operation flag, and the torque difference before limitation.

In a step S27, the torque difference FB amount is calculated using the torque difference calculated in the step S26.

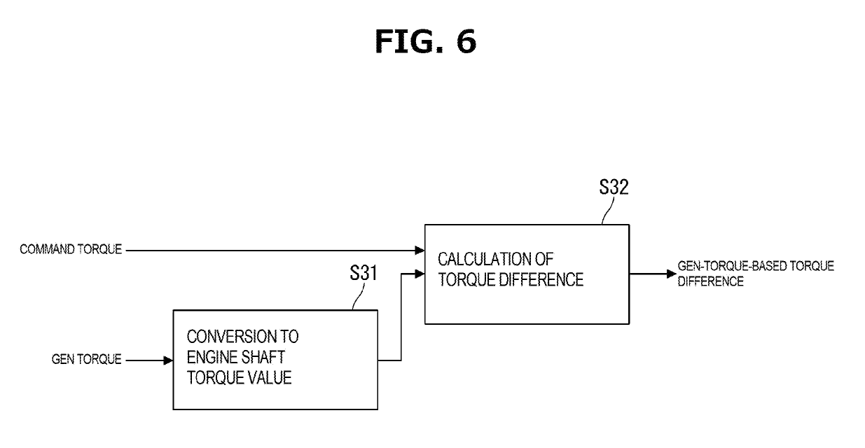

FIG. 6 is a block diagram showing an example of the calculation procedure for GEN-torque-based torque difference calculated in the step S23 of FIG. 5.

In a step S31, the power generation torque (GEN torque) of the generator 8 is converted to an engine shaft torque value that is the torque generated by the internal combustion engine 9. The engine shaft torque value is obtained, for example, by dividing the power generation torque by the speed ratio (gear ratio) of the speed reduction mechanism between the internal combustion engine 9 and the generator 8.

In a step S32, the GEN-torque-based torque difference that is the difference between the engine shaft torque value converted in the step S31 and the command torque of the internal combustion engine 9 is calculated.

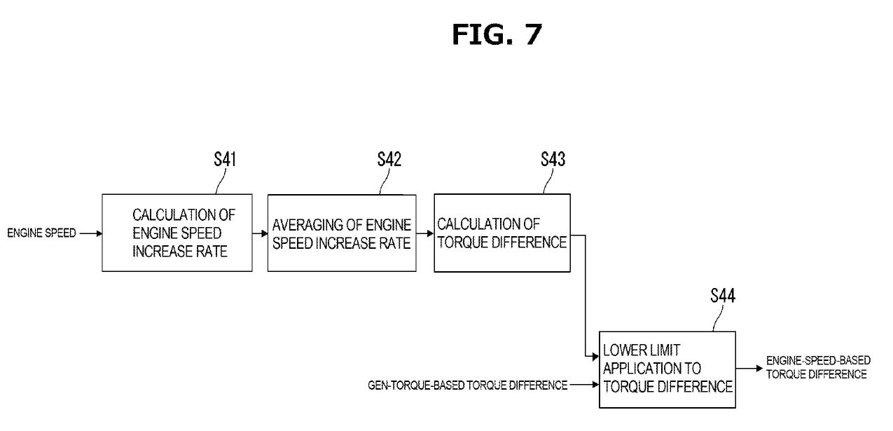

FIG. 7 is a block diagram showing an example of the calculation procedure for the engine-speed-based torque difference calculated in the step S24 of FIG. 5.

In a step S41, the engine speed increase rate (rotation increase rate) of the internal combustion engine 9 is calculated using the engine speed of the internal combustion engine 9. The engine speed increase rate is calculated, for example, using the previous value and the current value of the engine speed.

In a step S42, the engine speed increase rate of the internal combustion engine 9 is averaged to calculate an average engine speed increase rate. The average engine speed increase rate is, for example, the average value of the current value of the engine speed increase rate and the previous value of the engine speed increase rate.

In a step S43, an engine-speed-based difference before limitation is calculated using the average engine speed increase rate and the moment of inertia. The engine-speed-based torque difference before limitation is, for example, a value obtained by multiplying a torque based on the average engine speed increase rate by 2π and dividing the result by the inertia moment.

In a step S44, a lower limit is applied to the torque difference is performed using the GEN-torque-based torque difference and the engine-speed-based torque difference before limitation, and the engine-speed-based torque difference is calculated. In the step S44, the values of the GEN-torque-based torque difference and the engine-speed-based torque difference before limitation are compared, and the larger value (select-high) is set as the engine-speed-based torque difference.

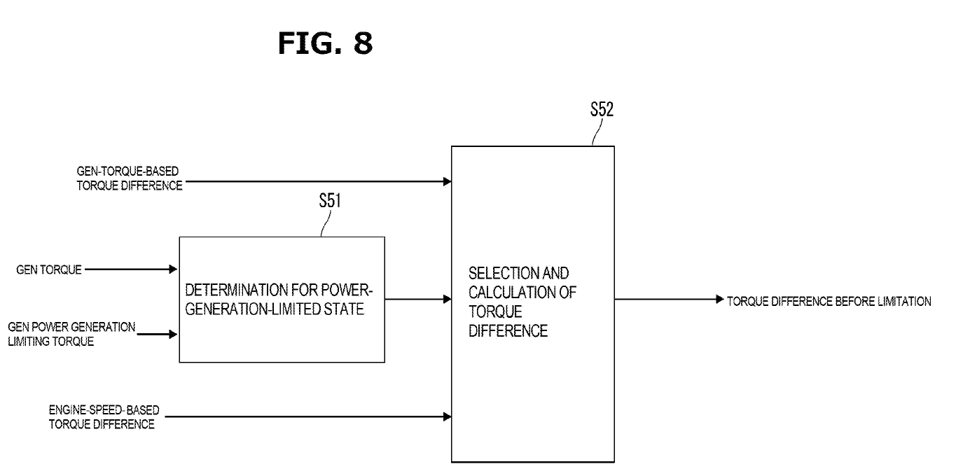

FIG. 8 is a block diagram showing an example of the calculation procedure for the torque difference before limitation calculated in the step S25 of FIG. 5.

In a step S51, it is determined whether the generator 8 is in a power-generation-limited state using the power generation torque (GEN torque) of the generator 8 and the GEN power generation limiting torque. Specifically, when the power generation torque (GEN torque) of the generator 8 equals the GEN power generation limiting torque, it is determined that the generator 8 is in a power-generation-limited state, and a GEN-torque power-generation-limitation non-determination flag is set to “1”. Furthermore, when the value the power generation torque (GEN torque) of the generator 8 is greater than that of the GEN power generation limiting torque, it is determined that the generator 8 is not in a power-generation-limited state, and the GEN-torque power-generation-limitation non-determination flag is set to “0”.

In a step S52, the torque difference before limitation is calculated using the GEN-torque-based torque difference, the engine-speed-based torque difference, and the GEN-torque power-generation-limitation non-determination flag. Specifically, in the step S52, when the GEN-torque power-generation-limitation non-determination flag is “1”, the engine-speed-based torque difference is selected and output as the torque difference before limitation. On the other hand, when the GEN-torque power-generation-limitation non-determination flag is “0” in the step S52, the GEN-torque-based torque difference is selected and output as the torque difference before limitation.

That is, in the step S52, when the power generation torque is greater than the GEN power generation limiting torque, the engine-speed-based torque difference calculated using the engine speed increase rate of the internal combustion engine 9 is output as a torque difference limitation.

As the above, one embodiment of the present invention has been explained in detail. However, the present invention is not limited to the above embodiments and various changes might be made to the embodiments without departing from the scope and spirit of the present invention. The present invention includes equivalents thereof.

The above-described embodiment relates to a control method and a control device for a hybrid vehicle.

The entire contents of Japanese Patent Application 2025-78454 filed May 9, 2025 is incorporated herein by reference.

1. A control method for a hybrid vehicle including an internal combustion engine for electric power generation which is mounted on the hybrid vehicle and a motor generator connected to drive synchronously with the internal combustion engine, the method comprising:
calculating a difference between a command torque for the internal combustion engine and a power generation torque of the motor generator; and
controlling the internal combustion engine such that the power generation torque approaches the command torque for the internal combustion engine by using the difference as a correction amount to an intake air amount of the internal combustion engine.

2. The control method for the hybrid vehicle according to claim 1,
wherein a rotational speed in the motor generator is controlled by a servo function of the motor generator.

3. The control method for the hybrid vehicle according to claim 1,
wherein a battery charged with electric power generated by the motor generator is provided, and
wherein when a limitation on the charging of the battery occurs, the electric power generated by the motor generator is limited.

4. The control method for the hybrid vehicle according to claim 1,
wherein a battery charged with electric power generated by the motor generator is provided, and
wherein in a case where there is a combustion continuation request of the internal combustion engine when a limitation on the charging of the battery occurs, the electric power generated by the motor generator is limited, and the command torque for the internal combustion engine is calculated according to the limitation of the generated electric power.

5. The control method for the hybrid vehicle according to claim 1,
wherein a battery charged with electric power generated by the motor generator is provided, and
wherein in a case where a torque generated by the internal combustion engine increases and an engine speed of the internal combustion engine increases when a limitation on the charging of the battery occurs, the difference between the command torque for the internal combustion engine and the power generation torque of the motor generator is calculated using a rate of increase in the engine speed of the internal combustion engine.

6. The control method for the hybrid vehicle according to claim 1,
wherein when a torque generated by the internal combustion engine exceeds an allowable limit torque of the motor generator, the difference between the command torque for the internal combustion engine and the power generation torque of the motor generator is calculated using a rate of increase in an engine speed of the internal combustion engine.

7. A control device for a hybrid vehicle including an internal combustion engine for electric power generation which is mounted on the hybrid vehicle and a motor generator connected to drive synchronously with the internal combustion engine, the control device comprising:
a control unit configured to:
calculate a difference between a command torque for the internal combustion engine and a power generation torque of the motor generator; and
control the internal combustion engine such that the power generation torque approaches the command torque for the internal combustion engine by using the difference as a correction amount to an intake air amount of the internal combustion engine.
